(19) United States
(12) Patent Application Publication
(10) Pub. No.: US 2025/0378154 A1
(43) Pub. Date: Dec. 11, 2025

(54) INTEGRATION SYSTEM AND METHOD FOR MANAGING CROSS-DOMAIN CONNECTIVITY, INTEROPERABILITY, AND AUTHENTICATION

(71) Applicant: Salesforce, Inc., San Francisco, CA (US)

(72) Inventors: Federico Piagentini, Buenos Aires (AR); Juan Francisco Li Puma, Daly City, CA (US); Daniel Vlad, Kirkland, WA (US); Franco Garcia, San Francisco, CA (US)

(73) Assignee: Salesforce, Inc., San Francisco, CA (US)

(21) Appl. No.: 18/740,497

(22) Filed: Jun. 11, 2024

(51) Int. Cl. G06F 21/44; G06F 8/34

(52) U.S. Cl. CPC G06F 21/44; G06F 8/34

(57) ABSTRACT

Apparatus and method for managing cross-domain connectivity, interoperability, and authentication. For example, some implementations rely on an external credential manager which securely stores user credentials for each respective service domain for which integration is to be performed. An introspection service searches an existing codebase to locate connector code that can be used for the integration, which are presented as options to the user within an integration development application. The connector code includes identifiers which indicate the credentials to request from the credential management service. The credentials are never provided directly to the integration platform, which generates a mapping between the placeholders and unique identifiers which identify the corresponding credentials. The mapping and the associated connector code are provided to the integration, which uses the mapping to inject the credentials into the connector code in accordance with the placeholders. The credentials are used for authenticating with service domains.

### TECHNICAL FIELD

One or more implementations relate to the field of computer systems for providing data processing services; and more specifically, to a system and method for managing cross-domain connectivity, interoperability, and authentication.

### BACKGROUND ART

Enterprise Service Bus (ESB) platforms, also known as integration platforms, provide a set of rules and principles for integrating different applications together over a virtual bus infrastructure. ESB products provide tools to enable users to construct integrations between multiple disparate service provider applications for integrating data and automating workflows and processes.

However, existing integration platforms do not provide comprehensive and adaptable connection management solutions for integrations, which must therefore be managed through manual coding by users. For example, current integration implementations do not provide solutions for integrating different authentication strategies for establishing and maintaining connections with different service domains. Adding this functionality is challenging and expensive given that current integration models are not built to support secure connection management and credentials handling required by the different service providers domains.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates an integration domain for integration development and deployment in accordance with some implementations.

FIG. 2 illustrates a transaction sequence for creating authentication credentials for a new connection in accordance with some implementations.

FIG. 3 illustrates a transaction sequence in which a new connection indicated from an integration code builder application causes a set of resources to be created within a connection management service.

FIG. 4 illustrates a transaction sequence for securely providing authentication credentials to an integration runtime in accordance with embodiments of the invention.

FIG. 5 illustrates an example of the integration runtime, a corresponding integration agent, and a set of extensions to provide a corresponding set of features.

FIG. 6 illustrates an example extension including an external handler and an internal handler.

FIG. 7 illustrates an example of a connectivity plugin of an integration runtime for initializing an authentication state.

FIG. 8 illustrates an example of an integration agent and extension with a deployment internal message handler and an authentication internal message handler.

FIGS. 9A-E illustrate various graphical user interface (GUI) features of one embodiment of an integration code builder application.

FIG. 10A is a block diagram illustrating an electronic device 1300 according to some example implementations; and

FIG. 10B is a block diagram of a deployment environment according to some example implementations.

### DETAILED DESCRIPTION

A system and method in accordance with implementations of the invention provide secure and seamless cross-domain connectivity to integrate two or more complex service domains. Integration components are constructed within an integration domain (also referred to as an integration platform) based on an understanding of the connection and authentication capabilities, security requirements, and protocols to connect to each distinct service domain, which may have different authentication requirements which rely on different authentication protocols. Integration development operations are performed by an integration domain, which manages service domain connectors and authentication credentials required to establish the connections between the different service domains. In some implementations, the integration domain securely accesses authentication credentials from an external connection management service, temporarily storing the authentication credentials in a secure storage. The authentication credentials are accessed from secure storage during deployment of the integration and injected into the respective connectors of the service domains, after which they are deleted.

In some implementations, an introspection service of the integration domain searches an existing codebase to locate connector code of any connectors that can be repurposed for the integration. For example, the existing codebase may include connector code defining connectors with authentication credentials to access each respective service domain. The introspection service may replace the authentication credentials from the connector code with placeholders, indicating where in the connector code the corresponding authentication credentials will be injected during deployment. As used herein, a placeholder refers to any form of encoding used to represent authentication credentials within a code sequence. In some implementations, the encoding includes references which can be interpreted to locate the authentication credentials. Once updated with placeholders, the introspection service may store the connector code back to the existing codebase.

Responsive to identifying connector code of any relevant connectors within the existing codebase (with or without placeholders), the integration platform accesses the connection management service to determine sets of existing authentication credentials which can be used in combination with the connectors, and then causes the existing connectors to be presented as options within an integration development application (which may be running in an end user device). The presentation of the existing connectors does not present the corresponding authentication credentials, but rather uses a name or other identifier associated with the existing connectors, to avoid exposing the underlying authentication credentials.

In some implementations, production credentials for the existing connectors (i.e., those to be used for the deployed integration) are never provided directly to the integration development application. Rather, responsive to a user selection of a particular connector, the integration platform may securely store the production credentials as secure properties in a secure properties storage, such as an encrypted key-value storage. In some implementations, the integration platform generates a mapping between the connector placeholders and unique identifiers (e.g., Universally Unique Identifiers or UUIDs) which identify the corresponding production credentials within the secure storage. Alternatively, the placeholders themselves may be updated to include the UUIDs. In other embodiments, the integration platform generates placeholders with hyperlinks or other type of encoding usable to locate the corresponding authentication credentials within the integration domain or within the connection management services of the external domain.

At deploy time, the integration platform deploys the connector code to a corresponding integration runtime (e.g., in a deployment environment such as a data center). During deployment, the mapping is used to access the production credentials as secure properties from the secure properties storage (e.g., identified via the corresponding universal IDs), decrypts the secure properties, and injects the resulting authentication credentials into the connector code (e.g., in place of the corresponding placeholders). Alternatively, hyperlinks or other encodings are used to directly access the corresponding authentication credentials from the external domain. For example, a hyperlink or code sequence may cause a request to be generated for the authentication credentials via an API of the connection management service.

Regardless of the particular mapping or encoding used, upon receipt of the authentication credentials, the integration runtime injects them into the connector code as previously described (e.g., in place of the corresponding placeholders). Once the credentials have been injected, the corresponding connector code is used for connecting to and authenticating with each respective service domain. If the authentication credentials were temporarily stored in the secure storage, they are deleted following deployment to ensure that the only valid copy of the authentication credentials are maintained by the connection management service.

Different types of authentication credentials may be used for different stages of the integration such as development, staging, and production, where a different set of security requirements are applied to each type of authentication credential in accordance with a set of permissions. The production credentials mentioned above are one type used only during deployment and protected from direct access by integration code builder tools. In some implementations, the production credentials may be temporarily stored in the secure storage for access during deployment and subsequently deleted.

Non-production authentication credentials, such as development credentials and staging credentials may also be defined using different sets of permissions to implement corresponding security requirements. Here, development refers to building the integration prior to deployment (e.g., writing integration code, downloading and referencing code libraries, performing program code debugging, etc.) and staging refers to running the integration in a private test environment (e.g., on staging servers at a data center or local to the integration domain). The particular type of authentication credentials may be selected from the integration code builder application and the corresponding set of permissions authentically implemented by the implementations described herein.

By way of example, and not limitation, the permissions for development credentials may provide read access to only those service domain resources required for building the integration (e.g., permission to read portions of the service domain source code); the permissions for staging may provide access to a wider set of resources, potentially including read, write, and execute permissions associated with the test environment (e.g., based on the requirements of the staging environment); and the permissions for production credentials may provide read, write, execute, and delete access to any resources required to run the production version of the integration (e.g., read, write, execute, and delete permissions within a particular platform environment such as a virtual machine or container).

As mentioned, each service domain may require different authentication techniques and protocols, including single-step authentication protocols, such as a user name and password, and multi-step authentication protocols, such as Open Authentication (OAuth) frameworks. The integration platform described herein generates integrations which support both single-step and multi-step authentication and manage the authentication credentials based on the type of authentication required by each respective service domain. For example, in some implementations, the integration runtime includes or is coupled to a connectivity plugin comprising an integration agent an extension associated with a particular multi-step authentication protocol. In some implementations, the connectivity plugin constructs the initial authenticator state for multi-step authentication such as those required by OAuth frameworks. Once the connectivity plugin initializes the authenticator state, the corresponding connector can then update the authenticator state as needed, in accordance with the OAuth protocol. For other types of authentication, such as those which require only a user name and password, or other static authentication information, the authentication credentials may be injected directly into the connector code at deployment as described herein.

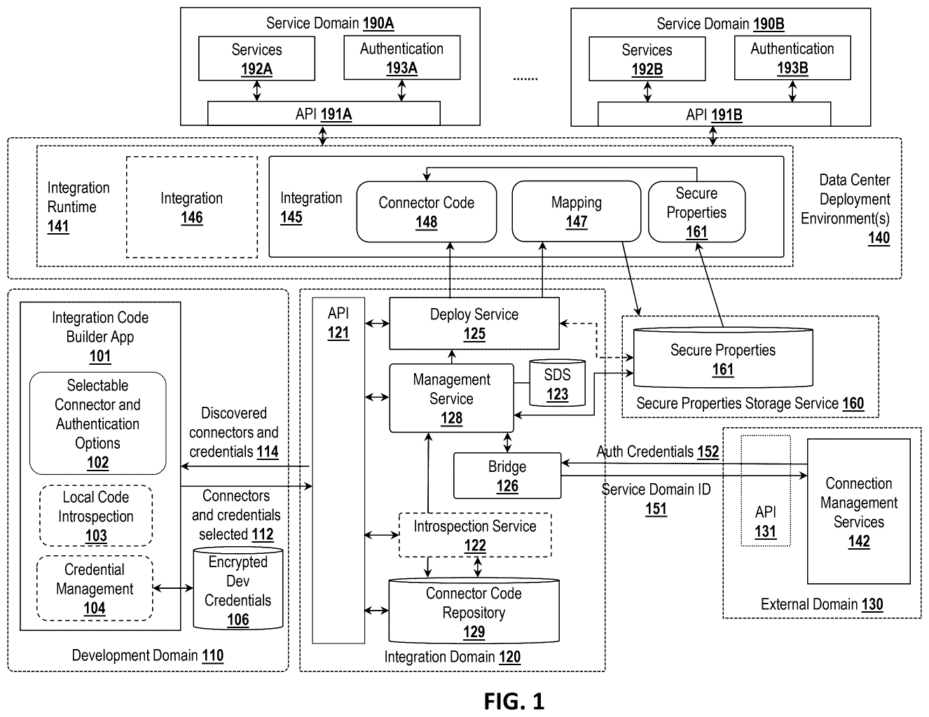

FIG. 1 illustrates one embodiment of an integration domain 120 (also sometimes referred to herein as the integration platform) for developing and deploying integrations 145-146 to provide integrated connectivity between different, normally incompatible service providers, represented by service domains 190A and 190B. In the illustrated implementation, integration 145 connects to each service domain, 190A and 190B, via a respective API, 191A and 191B, which provides access to one or more corresponding service domains 192A and 190B, respectively, and one or more authentication engines 193A and 193B, respectively.

In some implementations, one or more connection management services 142 running within an external domain 130 securely manage and store the authentication credentials required by each integration 145-146 for authenticating with a corresponding service provider (e.g., service domains 190A-B). Access to the connection management services 142 is limited by an API 131 exposed by the external domain 130. The integration domain 120 includes a bridge 126 configured to transmit and receive messages in accordance with the API 131. Components of the integration domain 120, such as the management service 128, described further below, use the bridge 126 to transmit messages indicating one or more service domain identifiers (IDs) 151 to request credentials 152 associated with the corresponding service domains (e.g., service domains 190A and/or 190B). In some implementations, the external domain 130 comprises various connection management services 142 which can include various services directed to managing connections and credentials associated with various service domains and managing authentication configurations for different forms of authentication. Limited access to these connection management services 142 is provided via the management domain API 131.

In some embodiments, the integration domain 120 comprises one or more electronic devices which execute program code to perform the various operations described herein for developing and deploying the integrations 145-146 within an integration runtime 141. While some examples below are described with respect to a first service domain 190A and a second service domain 190B, the operations and techniques described herein are applicable to integrations with any number of service providers.

In some implementations, in response to a user specifying an integration between the first service domain 190A and the second service domain 190B (e.g., by selecting or entering corresponding server provider IDs via the integration code builder application 101), an introspection service 122 introspects connector code in a connector code repository 129 to determine if the stored codebase includes existing connectors for connecting to the first and second service domains 190A-B. In some implementations, one or more connectors in the connector code repository 129 are placeholder-based connectors which include placeholders indicating the location of authentication credentials managed by the connection management services 142 or stored as secure properties 161 by a secure properties storage service 160 (e.g., as encrypted key-value properties). The placeholders may be encoded with links to identify the corresponding authentication credentials (e.g., unique identifiers and/or hyperlinks associated with the authentication credentials).

In cases where certain connectors identified by the introspection service 122 include actual authentication credentials embedded directly in the connector code, rather than placeholders (e.g., stored in a non-compliant manner or based on outdated security requirements), the introspection service 122 strips out the existing authentication credentials from the connector code and replaces them with placeholder code corresponding to locations at which new or existing authentication credentials can be injected (e.g., during deployment of the corresponding integration as described herein). The placeholders, for example, may include a hyperlink or other encoding to access the connection management services 142 in the external domain 130 to retrieve the corresponding authentication credentials. In some embodiments described herein, the management service 128 accesses the authentication credentials from the connection management services 142 (e.g., using the placeholders) and temporarily stores the authentication credentials as secure properties 161 within a secure properties storage service 160. The management service 128 may then update the placeholders with unique identifiers and/or generate a mapping between the placeholders and unique identifiers for locating corresponding locations of the authentication credentials in the secure properties 161. Alternatively, the above operations may be performed by the deploy service 125 during the deployment process (as indicated by the dotted line to the secure properties 161).

In some implementations, the authentication credentials 152 to be injected in new and existing connectors are never provided directly to the development domain 110 (e.g., such as integration code builder application 101). Rather, responsive to a user selecting an existing connector or submitting a new connector (e.g., via selectable connector and authentication options 102 presented within a graphical user interface (GUI)), a management service 128 of the integration domain 120 generates a request message with a service domain identifier (ID) 151 corresponding to a service domain for which credentials are needed (e.g., service domains 190A or 190B). The request message is transmitted by the bridge 126 to the API 131 of the external domain 130, which forwards the request to the appropriate one of the connection management services 142. As mentioned, in some implementations, the management service 128 (or the deploy service 125) stores the authentication credentials 152 as secure properties 161 in a secure properties storage service 160 (e.g., encrypted and stored as key-value pairs). The management service 128 may associate a unique identifier (e.g., a Universally Unique Identifier or UUID) with each authentication credential and generate a mapping 147 between the unique identifiers and the secure properties 161 in the secure properties storage service 160. In some embodiments, the management service 128 updates the corresponding connector code 148 with the unique identifiers (e.g., in place of or integrated within the existing placeholders). In certain implementations, the mapping 147 may comprise hyperlinks or other encodings which identify the corresponding authentication credentials on the connection management services 142 (e.g., so that they may be fetched directly from the connection management services 142 during deployment, rather than from the secure properties storage service 160).

In some implementations, the set of selectable connector and authentication options 102 includes combinations of the discovered connectors and authentication credentials 114 (e.g., connectors discovered in the connector code repository 129 and authentication credentials 152 provided by the connection management services 142 in response to provided service domain IDs 151) as well as options to create new connectors and/or enter new authentication credentials. An indication of the options selected for connectors and credentials 112 is provided to the integration domain 120 which performs the necessary operations. For example, if existing authentication credentials 152 are selected for a new or existing connector, the management service 128 coordinates with the connection management services 142 to ensure that the authentication credentials are available for injection into the connector code 148 as described herein (e.g., accessing the credentials via the bridge 126 and storing them as secure properties 161 as described herein with respect to some embodiments). If new authentication credentials are provided, the management service 128 sends a request to the connection management services 142 to store and manage the new authentication credentials, and may also store them as secure properties 161 for deployment (e.g., after acknowledged by the connection management services 142). Alternatively, the deploy service 125 may store the new authentication credentials in the secure properties 161 during deployment.

If a new connector is provided, the management service 128 stores the corresponding connector code in the connector code repository 129. Local code introspection logic 103 of the integration code builder application 101 continually or periodically introspects the new connector code while open in the integration code builder application 101 to identify locations in the new connector code corresponding to authentication credentials. The local code introspection logic 103 may indicate these locations by inserting placeholders and cause additional selectable authentication options to be presented when the cursor is in the vicinity of the placeholders. For example, the additional selectable options may include a prompt to the user to enter new authentication credentials or to choose existing authentication credentials for association with the placeholders. In the case of new credentials, the management service 128 sends a request to the connection management services 142 to store and manage the new authentication credentials, and may also store the credentials as secure properties 161 for deployment. In the case of existing credentials, the management service 128 may request them for temporary storage in the secure properties 161. In both cases, the management service 128 provides a mapping 147 linking each placeholder to the corresponding set of authentication credentials.

The management service 128 may generate a mapping 147 which maps each placeholder to a location in the secure properties 161 stored in the secure properties storage service 160. For example, the mapping 147 may associate each placeholder with a unique identifier indicating the location of the corresponding authentication credentials in the secure properties 161. Alternatively, the encoding may indicate the authentication credentials stored by the connection management services 142 in the external domain 130 (e.g., via a URL). Any type of encoding may be used in the mapping 147 to locate the corresponding authentication credentials.

Regardless of the type of encoding used, in these embodiments, the authentication credentials to be used during deployment (sometimes referred to herein as production credentials) are prevented from exposure to the development domain 110 and are managed exclusively by the connection management services 142, thereby ensuring that the authentication credentials are protected. While the authentication credentials may be temporarily stored as secure properties 161 in the secure properties storage service 160 in some implementations, they are deleted as soon as the integration 145 has been successfully deployed.

At production time, a deploy service 125 deploys the connector code 148 and the corresponding mapping 147 to the integration 145 and/or the integration runtime 141 executing in a data center deployment environment 140. The integration 145 or integration runtime 141 uses the mapping 147 to access the secure properties 161 from the secure properties storage service 160 (e.g., identified via the corresponding universal identifiers), decrypts the secure properties, and injects the corresponding authentication credentials into the connector code 148 (e.g., in place of the corresponding placeholders/universal identifiers).

The connector code 148 of the integration 145 is then executed with the injected authentication credentials to authenticate with each respective service domain 190A-B. In some implementations, after the secure properties 161 are accessed by the integration 145 using the mapping 147, the management service 128 deletes them from the secure properties storage service 160 to ensure that the connection management services 142 have the only valid copy of the authentication credentials.

In various embodiments described herein, the placeholders in connectors may be replaced by values specified in one or more properties files (or other data structure types), such as the unique identifiers previously described for accessing the secure properties 161 from the secure properties storage service 160. In these implementations, when a placeholder is identified in connector code, the properties file is accessed using a corresponding unique identifier and the placeholder is replaced with the corresponding value from the properties file (e.g., the corresponding authentication credentials). In these implementations, the underlying connector code in the connector code repository 129 is not modified; rather, the required data is injected in place of the corresponding placeholders during deployment.

If the authentication credentials used by an integration 145 are ever modified by a user (e.g., such as by changing the user name and password), then the deploy service 125 must redeploy the integration 145 with the updated values, which may be retrieved from the connection management services 142 as described herein. Some implementations include a tracking service to track these modifications and to implement versioning (e.g., to track the different versions of the authentication credentials). Because changing the authentication credentials will break a deployed integration 145, warnings are provided in the integration code builder application 101 when a user attempts to change the authentication credentials or make modifications to other required properties of the integration 145.

Multiple connector versions may exist for a given service domain (e.g., 190A), with each connector version relying on a particular schema for representing authentication credentials. By way of example, and not limitation, if the connector code repository 129 stores five different connector versions for connecting to a particular service domain, four of the connector versions may be compatible with a first schema and one may be compatible with a second schema. In this example, the first schema may specify authentication with a user name and password and the second schema may specify authentication with a multi-step authentication protocol such as OAuth. Moreover, different schemas may be specified for different versions of a given authentication protocol (e.g., a first schema for OAuth v1.0 and a second schema for OAuth v2.0). In these implementations, the different schemas may be stored with the corresponding connector code versions in the connector code repository 129 and accessed by the management service 128 as described herein.

The following is an example code block indicating connectors and corresponding connector versions discovered by the introspection service 122 in response to searching the connector code repository 129 (where location refers to a placeholder location):

```
{
  “connectorId”: “JIRA”,
  “version”: “1.0.100”
  “location”: “/flow/0/step/3/”
},
{
  “connectorId”: “JIRA”,
  “version”: “1.0.100”.
  “location”: “/flow/1/step/2/”
},
{
  “connectorId”: “Slack”,
  “version”: “3.0.1”,
  “location”: “/flow/0/step/2/”
}
```

A request may then be sent to the management service 128 to identify the schemas corresponding to these connector versions. As illustrated in FIG. 1, the management service 128 may use the connector versions to query a schema data store 123 to identify the corresponding schemas and the required input fields and types based on the schemas. The discovered connectors and corresponding schemas may then be presented within the selectable connector and authentication options 102 of the integration code builder application 101. In response to selection of a particular connector, the corresponding schema may be used to request the respective authentication credentials from the connection management services 142.

A schema, for example, may comprise a representation of the required input of a connector, as in the following example with authentication credentials comprising a user name and password for version 1.0 of a connector with a connector ID of JIRA:

```
{
“connectorId”: “JIRA”,
“schema Version”: “1.0”,
“compatibleConnectorVersions: [“1.0.99”, “1.0.100”],
“input”: {
  “username”:
        “type”: “String”,
        “term”: “regular”
  },
  “password”: {
        “type”: “String”,
        “term”: “secret”
  }
}
}
```

The above example allows the user to learn the required input fields to create a connection with a specific connector for a specific service domain.

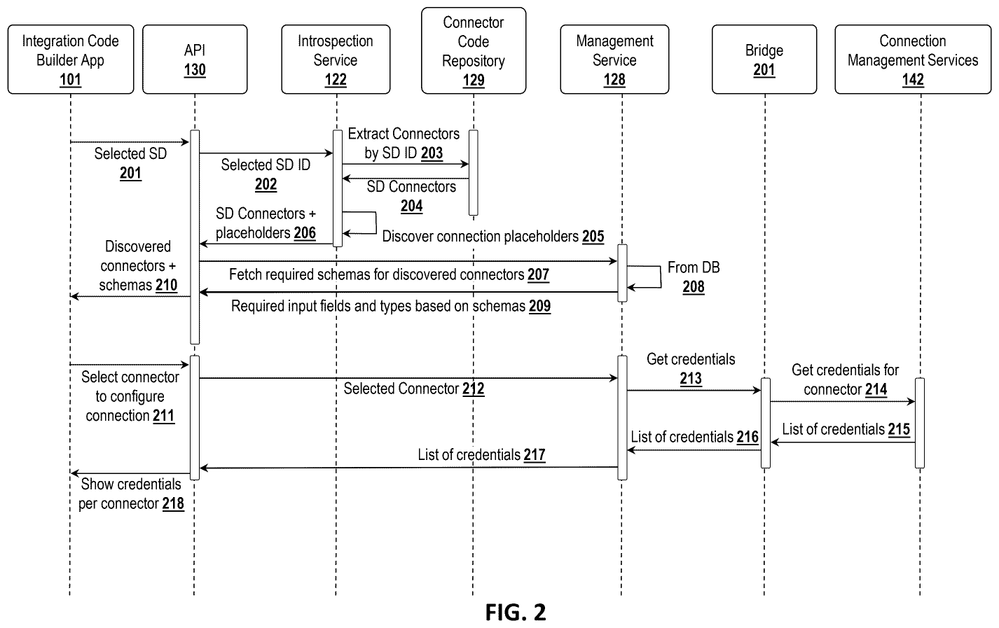

FIG. 2 illustrates an example of the above-described transaction sequence in which the introspection service 122 searches the codebase in the connector code repository 129 to discover existing connectors and corresponding placeholders (aka, locations) and the management service identifies the corresponding schemas.

In response to user input via the GUI of the integration code builder application 101, the service domain (SD) selected for an integration is communicated to the API 121 at 201, which communicates the service domain ID to the introspection service at 202. At 203, the introspection service 122 uses the service domain ID to search for existing connectors in the connector code repository 129 and receives the corresponding connectors at 204 (also sometimes referred to herein as “artifacts”).

At 205, the introspection service identifies locations of placeholders in the connectors (e.g., where authentication credentials are to be injected as described herein) and may mark these portions of the connector code such as by indicating the locations the placeholders and/or mapping the placeholders to unique identifiers as described herein. At 206, the connectors and identified placeholders are provided to the API 121 of the integration domain 120.

As mentioned, a different schema, identified via a schema ID, may be used for each authentication type. At 207, the API 131 requests the required schemas for the discovered connectors from the management service 128, which searches a schema data store 127 using the schema IDs at 208. The management service 128 locates the schemas and sends a response with an indication of the required input fields and types corresponding to the schemas (e.g., at the locations of the placeholders). At 210, the API provides the discovered connectors with corresponding schemas to the integration code builder application 101, which presents them to the user in the selectable connector and authentication options 102.

In response to the user selecting a particular connector from the presented options, at 211-212, an indication of the connector is provided through the API 121 to the management service 128. At 213-214, the management service 128, requests (via the bridge 201), existing credentials for the selected connector from the connection management services 142, which responds at 215-216 with an indication of existing credentials for the connector, which is passed via the API 121 to the integration code builder application at 217-218 for presentation in the integration code builder application 101.

As mentioned, the actual authentication credentials are not provided at 215-218. Instead, a textual label or other identifier corresponding to the authentication credentials may be provided. For example, each authentication credential in the response may be represented by a label such as [servicedomain-authscope], where servicedomain is a name associated with the service domain for which an integration is to be performed and authscope indicates the set of permissions associated with the authentication credentials, as defined by credential type. For example, a first set of authentication credentials may be used during the development process (e.g., authscope =dev) with a limited set of permissions (e.g., permissions to run code for testing purposes during development); a second set of authentication credentials may be used during the integration staging process (e.g., authscope =staging), potentially with a more expansive set of permissions (e.g., permissions to run the code on a test platform); and a third set of authentication credentials may be used for deployment of the integration (e.g., authscope =deploy) with the most extensive set of permissions (e.g., permissions to run the integration in the integration runtime). Each of these may be presented as selectable options 102 within the integration code builder application 101. In some implementations, the options are filtered based on the identity of the current user of the integration code builder application 101. For example, if the user is expected to participate in development, but not staging or deployment, then only the development option may be presented.

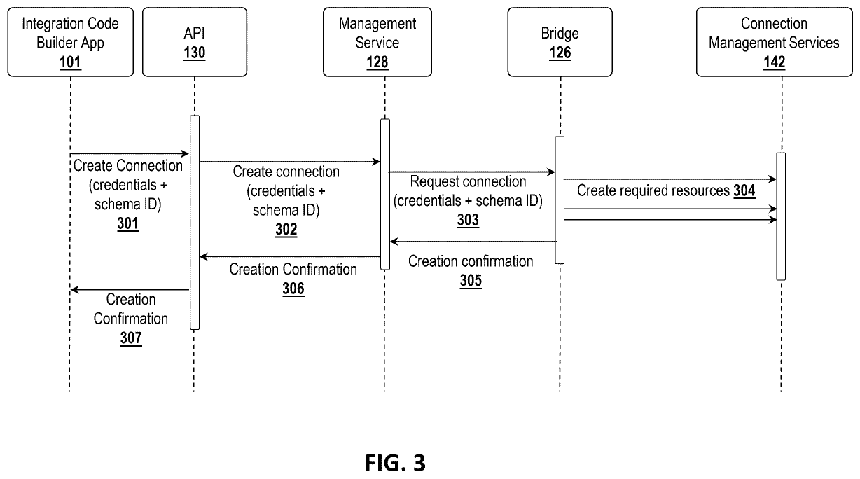

FIG. 3 illustrates an example transaction sequence in which a new connection is indicated with a new set of authentication credentials, based on the schemas provided in FIG. 2. As used herein, a “connection” refers to a combination of authentication credentials and a corresponding schema required for connecting to a service domain. A first message 301 is sent from the integration code builder application 101 to the API 121 which sends a corresponding message 302 to the management service 128 of the integration domain 120 indicating a connection to be created with new authentication credentials corresponding to the schema ID. In response, the management service 128 sends a request 303 indicating the credentials and schema ID to the bridge 126, which generates a sequence of transactions 304 to create the required resources within the connection management services 142 for managing the specified authentication credentials. As mentioned, the bridge 126 is configured to communicate via the API 131 of the external domain 130 to send requests to the connection management services 142. Once the required resources are successfully allocated by the connection management services 142, a confirmation is sent via messages 305-307 (i.e., from the bridge 126 to the integration code builder application 101 through the API 121) indicating that the connection has been successfully created and that the new authentication credentials are managed by the connection management services 142.

By way of example, and not limitation, the following schema indicates authentication credentials of a user name and password:

```
{
    “schemaId”: “2”,
    “input”: {
                “username”: “someUsername”,
                “password”: “somePassword”
    }
}
```

Here, the schema identifier is 2 and the authentication requirements include only a user name and password.

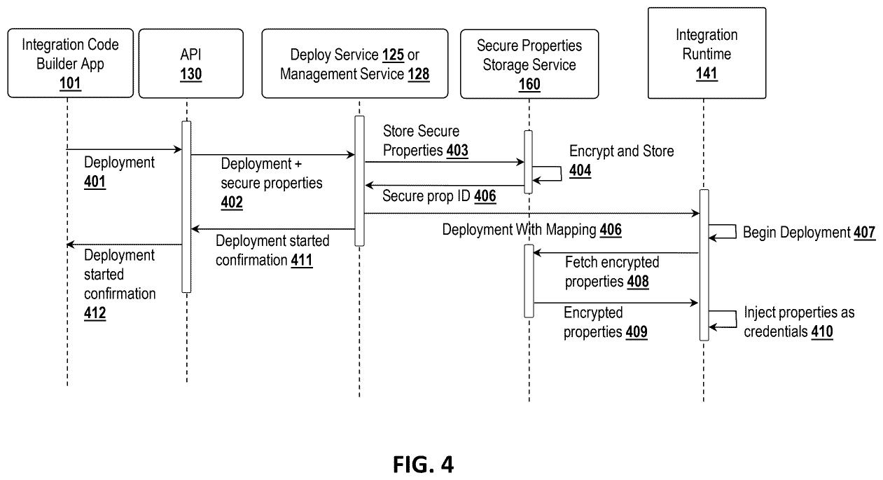

FIG. 4 illustrates an implementation in which authentication credentials (whether newly created or existing) are temporarily stored as secure properties within the secure properties storage service 160 and accessed during deployment. At 401, deployment is initiated from the integration code builder application 101. At 402, the API 121 sends a deployment command with secure properties to the deploy service 125 or the management service 128. The secure properties may be generated by converting the authentication credentials to a key-value format. At 403, the deploy service 125 or management service 128 sends a message to the secure properties storage service 160, which encrypts and stores the secure properties at 404, and provides one or more corresponding secure properties identifiers to the deploy service or management service at 406. The secure properties identifiers may be the unique identifiers previously described, which are used to create a mapping between the placeholder locations in the corresponding connector and the relevant key-value secure properties in the secure properties storage service 160 (e.g., where each unique identifier is the key and the corresponding value is the authentication credential).

At 406, the deploy service 125 or management service 128 requests deployment and provides the mapping to the integration runtime 141 and/or the integration 145. At 407 the integration runtime 141 initiates deployment and, using the mapping, fetches the relevant secure properties corresponding to the authentication credentials at 408-409. At 410, the integration runtime injects the properties as credentials into the relevant connectors (e.g., at the placeholder locations as previously described).

Thus, in these embodiments, each authentication credential is associated with a unique identifier, encrypted, and temporarily stored in the secure properties storage service for deployment. The authentication credential is only extracted and injected once by the integration runtime 141 so that it travels over the network only when needed for deployment. In some embodiments, the corresponding secure properties are automatically deleted from the secure properties storage service 160 once they are provided to the integration runtime.

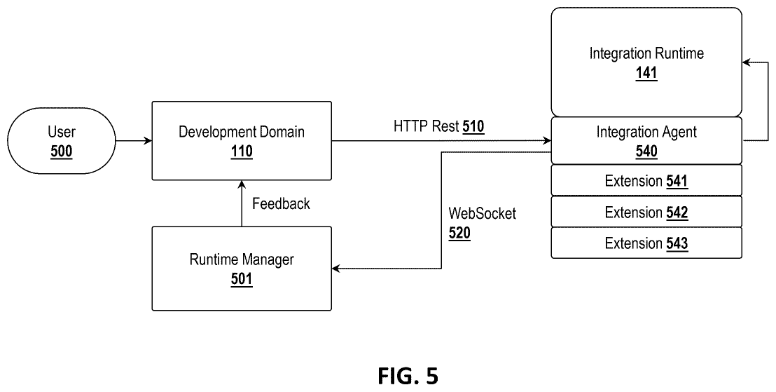

In some implementations, the integration runtime 141 uses an agent-based architecture comprising one or more integration agents configurable with extensions. FIG. 5 illustrates an example of the integration runtime 141, a corresponding integration agent 540, and a set of extensions 541-543, each of which may be associated with a different function. The combination of the integration agent 540 and extensions 541-543 is sometimes referred to herein as a connectivity plugin. The integration agent 540 of these embodiments provides extensibility to the integration runtime 141, acting as a central point for all incoming and outgoing traffic which it curates, filters, and processes. In some implementations, the integration agent 540 runs in the same virtual machine (VM) as the extensions described herein (e.g., a Java VM (JVM)) and supports communication which accommodates different types of runtime deployments such as:
HTTP Rest: An API can be opened to enable communication with the development domain 110 for managing integrations and configuring the integration runtime 141 and the existing integrations (e.g., integrations 145-146). In the example shown in FIG. 5, in response to input from a user 500, the development domain submits an HTTP Rest connection 510 to the integration agent 540. The message may include an instruction or command to perform an integration control operation such as deploying an integration, deleting the integration, and restarting apps associated with the deployment and/or the integration runtime 141.
WebSocket: A WebSocket connection 520 is illustrated from the integration agent 540 to a runtime manager 501 for reporting information such as alerts and statistics. In this implementation, the WebSocket connection comprises a communication channel for pushing notifications in an asynchronous manner from the integration runtime 141. The reported information may include, for example, the status of the deployed integrations (e.g., running, starting, stopped, etc.), relevant statistics (e.g., CPU utilization, memory utilization, storage levels, etc.), and alerts. The runtime manager 501 may comprise the management service 128 or a component thereof, or may be a separate management component dedicated to receiving and processing WebSocket information.

The ability to add and remove extensions 541-543 provides extensibility to the integration agent 540. In the illustrated example, one or more of the extensions 541-543 may provide the integration agent 540 functions to communicate with internal APIs of the integration runtime 141. The extensions 541-543 are provided access to any transports offered by the integration agent 540 for communication with external components. For example, an extension 541-543 can open a new endpoint in an HTTP Rest server or send new data using the existing WebSocket 520, as described further below. New extensions 541-543 may be added to maintain compatibility as new communication requirements and protocols are established.

The extensions 541-543 may be installed by default depending on the deployment type or the target, where the integration runtime 141 executes or can be explicitly included at deployment time. For example for those integration runtimes running CloudHub 2.0 (Kubernetes), the HTTP Rest may be disabled by default and a monitoring extension may be used (e.g., extension 541) which relies on the WebSocket connection to send statistics of the integration runtime 141 and the integrations into a single-tenant or multi-tenant architecture dedicated to each customer (e.g., based on payment type). In some implementations, the extensions 541-543 are encoded in Java Archive (jar) files included in the same JVM as the integration runtime 141 and the integration agent 540, although various other types of source file encoding may be used. Classloading isolation may be employed at a global level to prevent issues between the different components of the JVM.

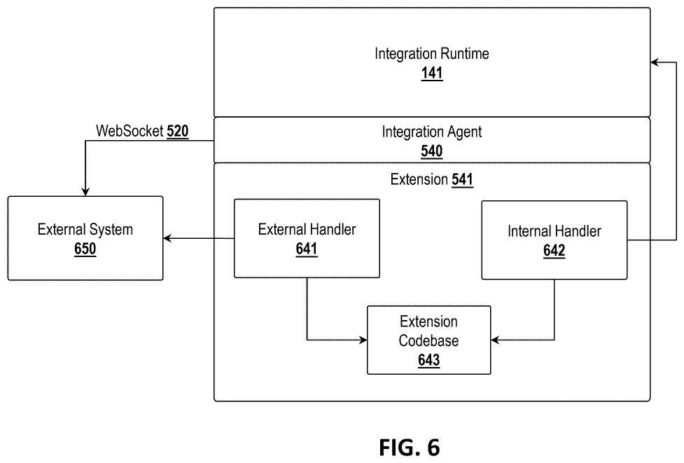

FIG. 6 illustrates another representation of the integration runtime 141, integration agent 540, and an extension 541 configured with an external handler 641 for communicating with an external system 650 (e.g., such as the integration domain 120, development domain 110, external domain 130, etc.) and an internal handler 642 for communicating with components of the integration runtime 141 in accordance with an extension codebase 643. In these embodiments, the extension 541 follows a specific architecture to ensure the level of security and governance required by the integration agent 540. The combination of the integration agent 540 and extension 541 provides two ways to interact with both the outside world and the integration runtime 141. For example, the external message handler 641 supports the creation of new endpoints in the external system 650 that the integration agent 540 communicates with through the WebSocket connection 520. The following is an example code sequence:

```
@Named(“TYPE_OF_MESSAGE_THAT_MUST_DISPATCH”)
@Singleton
public class MyRequestHandler extends
WebSocketExternalMessageHandler
{
  @Inject
  private IntegrationService ServiceInTheAPIModule;
}
```

The internal handler 642 accesses exposed components of the integration runtime 141. For example, in some embodiments, the internal handler 642 listens for certain types of activity inside the integration runtime 141, such as listening for events in the deployment process (e.g., before deploy actions, after deploy actions, etc.), altering the list of properties injected, and accessing the authentication state (e.g., such as the authentication state required by certain multi-step authentication protocols as described herein) which is handled internally by the integration runtime 141. The following is an example code sequence of an internal handler 642:

```
@Named(“my.company.internal.handler”)
@Singleton
public class MyInternalMessageHandler<AgentDomainObject>
implements
InternalMessageHandler<AgentDomainObject>{
  boolean handle(AgentDomainObject message){
      // TODO handle message
  }
}
```

Multi-step authentication protocols, such as Open Authentication (e.g., OAuth 1.0, 2.0, and 2.1) require more than a single request to generate and maintain authenticated connections to service domains within an integration. Because these types of complex security protocols cannot be managed with static property injections, embodiments of the invention rely on the integration agent 540 and extension 541 that operate transparently to the integration runtime 141 and enable overwriting of the default authentication state (e.g., the OAuth state when OAuth is used), which may then be accessed by any OAuth-based connectors in the integration runtime.

By way of an overview, OAuth requires two main transactions: (i) transactions to generate the initial accessToken and refreshToken; and (ii) transactions for making requests using the accessToken and receiving an acquiring an updated access Token using the refresh Token when needed.

### (i) Generating the Initial accessToken and refreshToken

For the initial accessToken and refresh Token transactions, a request is sent to an authorization server for explicit authorization, listing all the resources that will be made available from a service domain. A temporary code is then returned to the requestor in a callback URL which generates a new request to exchange the code for the access Token and refresh Token.

In some implementations described herein, the granting of authentication credentials can be simplified by making a request using a client identifier (the clientId) and a secret (clientSecret) and receiving the tokens without the need for explicit user authorization. In either case, these transactions are only performed once, at the creation of a connection, and subsequent operations are handled by (ii).

### (ii) Requests to Receive an Updated accessToken with the refreshToken

For an integration 145 and integration runtime 141 using OAuth to communicate with a service domain 190A (used here as an example service domain which requires OAuth), each request to the service domain 190A includes a header with the accessToken which the service domain uses to validate the request. The accessToken will eventually expire and therefore must be refreshed periodically. The implementations described herein include architectural features to autonomously access the initial accessToken and refreshToken and subsequently perform updates in accordance with the version of OAuth in use. These implementations inject the access Token and refresh Token seamlessly into the integration runtime 141, supporting connectivity with the service domain 190A in accordance with the required OAuth state.

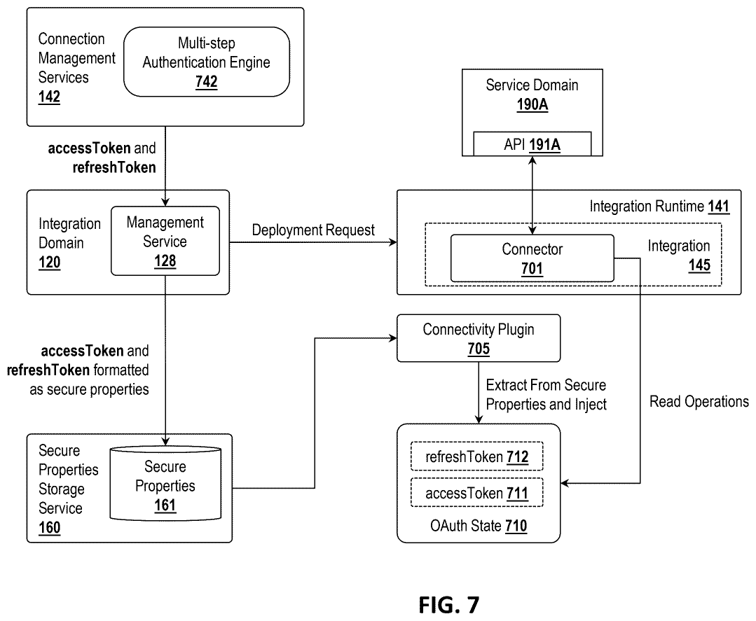

FIG. 7 illustrates an example implementation with a connector 701 of the integration 145 and the corresponding integration runtime 141. A connectivity plugin 705 is illustrated for initializing the OAuth State 710 in response to deployment requests 720. The OAuth state 710 includes the accessToken 711 and refresh Token 712 which are read via the connector 701. As mentioned, the connectivity plugin 705 may comprise the combination of the integration agent 540 and extension 541 previously described, although the underlying principles of the invention are not limited to this particular architecture.

In one implementation, the connection management services 142 include a multi-step authentication engine 742 for managing multi-step authentication credentials such as those required by OAuth for authenticating with service domain 190A. In this implementation, the management service 128 requests a copy of the current OAuth state 710 from the multi-step authentication engine 742 (via the bridge 126) and stores the accessToken and refresh Token as secure properties 161 within the secure properties storage service 160. The secure properties may then be accessed by the connectivity plugin 705, which extracts the refresh Token and access Token from the secure properties. The connectivity plugin 705 may reformat the tokens as required to reproduce the current OAuth state 710 in a storage or memory location accessible to the connector 701. Once stored in an accessible location, any connector to the service domain 190A can access the OAuth state 710 for authentication.

In these embodiments, the multi-step authentication engine 742 supports data elements required to implement the OAuth protocol and provide them in response to requests from the management service 128. These elements can include, for example:
clientId
clientSecret
authorizationUrl
tokenUrl
Scopes
   The multi-step authentication engine 742 may also persistently store the original accessToken and refresh Token for implementations in which the tokens may be utilized in several integrations at the same time.

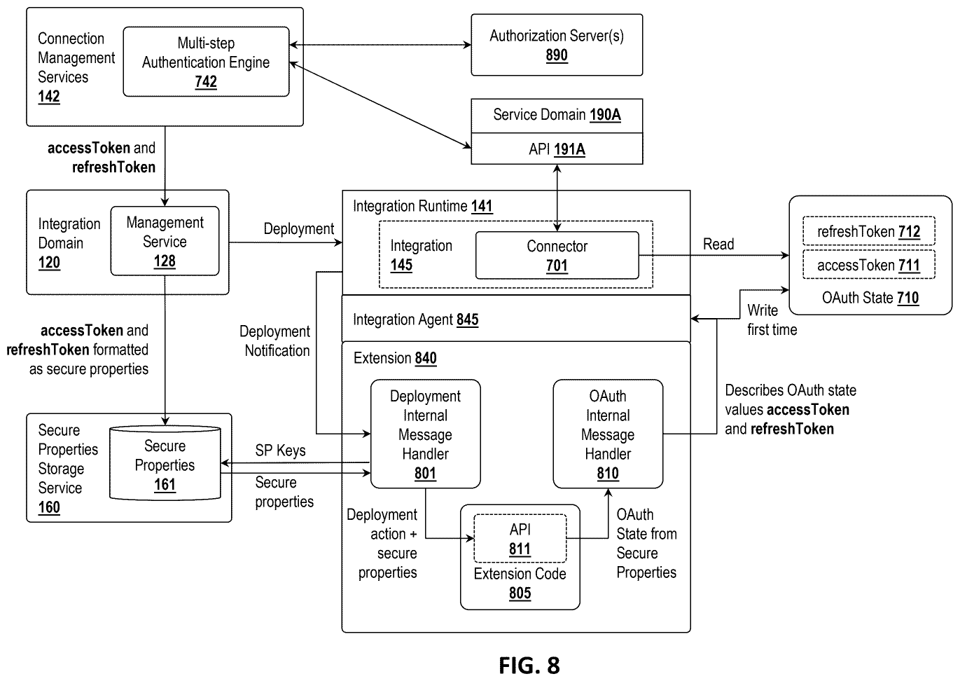

FIG. 8 illustrates additional details of the connectivity plugin, including the integration agent 845 and extension 840 for managing multi-step authentication states. While OAuth is used as an illustrative example, the underlying principles of the invention may be implemented using any type of multi-step authentication. The multi-step authentication engine 742 may generate the initial authentication state based on transactions with one or more authorization servers 890 and the corresponding service domain 190A. For example, if OAuth 2.0 is used for authentication with the service domain 190A, the initial OAuth state is generated through an authorization transaction with an authorization server 890, followed by a token request transaction with the authorization server 890 (or potentially a different authorization server). As a result of these transactions, the multi-step authentication engine 742 is provided with an accessToken 711 and a refresh Token 712 of the OAuth state 710, which can be used to access resources in the corresponding service domain 190A. In accordance with the OAuth protocol, the refresh Token must be periodically used to refresh the accessToken (i.e., obtain an updated accessToken), requiring additional transaction sequences.

As mentioned above with respect to FIG. 7, in preparation for deploying the integration, the management service 128 receives the accessToken and refresh Token from the connection management services 142 and stores them as secure properties 161 within a secure properties storage (e.g., via the bridge 126 as previously described with respect to other authentication credentials). The integration agent 845 and extension 840 are then triggered in response to detecting a deployment of the corresponding integration 145 to reproduce the OAuth state 710 from the secure properties 161.

In this example, the connector 701 deployed with the integration 145 needs to be capable of accessing the API 191A of service domain 190A in accordance with the current OAuth state 710. The integration agent 845 and extension 840 initialize the OAuth state 710 at deployment to avoid the complex transaction sequences typically required by OAuth (e.g., requesting authorization from an authorization server, requesting a token, and requesting resources). In this embodiment, a deployment internal message handler 801 listens for deployment actions and/or receives deployment notifications from the integration runtime 141 when an integration 145 is deployed. When a connector 701 of the integration 145 uses OAuth authentication (or a similar multi-step authentication type), the deployment internal message handler 801 reads the corresponding secure properties 161 from the secure properties storage service 160 based on the mapping 147 (e.g., generated by the integration domain as previously described for other types of authentication credentials) and passes them to an API 811 of the extension code 805.

The extension code 805 reconstructs the OAuth state 710, including the accessToken 711 and refresh Token 712, from the secure properties 161, e.g., reformatting the secure properties to reconstruct the OAuth state 710 in accordance with the defined OAuth state format. An OAuth internal message handler 810 provides the OAuth state 710 to a location accessible to the integration runtime 141 so that it can be accessed by the corresponding connector 701 as needed in accordance with the authentication requirements of the corresponding service domain 190A. For example, the OAuth state 710 may be persistently stored in a particular file and/or file directory of a corresponding hardware platform (e.g., ‘.integration/oauth/’ and using a file name corresponding to a name or other identifier corresponding to the integration).

In some implementations, the extension 840 sets the initial OAuth state 710 based on the secure properties 161 to avoid the need for the initial complex series of OAuth transactions (e.g., authorization requests/responses, access token requests/responses, etc.). After the initial OAuth state 710 is set by the OAuth internal message handler 810, the corresponding connector 701 manages the connection, refreshing of the accessToken 711 and refresh Token 712 through communication with the service domain 190A and/or authorization server(s) 890 in accordance with the OAuth protocol. As the OAuth state 710 is refreshed, the new values of refreshToken 712 and accessToken 711 are persistently stored in the specified location and also potentially updated on the connection management services 142.

Thus, embodiments of the invention described herein leverage existing connection management services 142 for both existing and new integrations. Connection management services 142 are leveraged not only at deploy time but also during design time. For example, integrations may be tested with test credentials at design time within integrated development environments (IDEs), such as the integration code builder application 101, which represents a variety of different IDEs within the development domain 110.

In various implementations, the integration code builder application 101 provides a user interface for adding connectors, such as connector 701, to an integration 145 using graphical presentations of options, drag & drop actions, and/or a code editor window to edit the connector code, which in some implementations uses an XML encoding as described herein. When required, the integration code builder application 101 may authenticate each user to access the external domain 130 and retrieve corresponding authentication credentials for a particular integration.

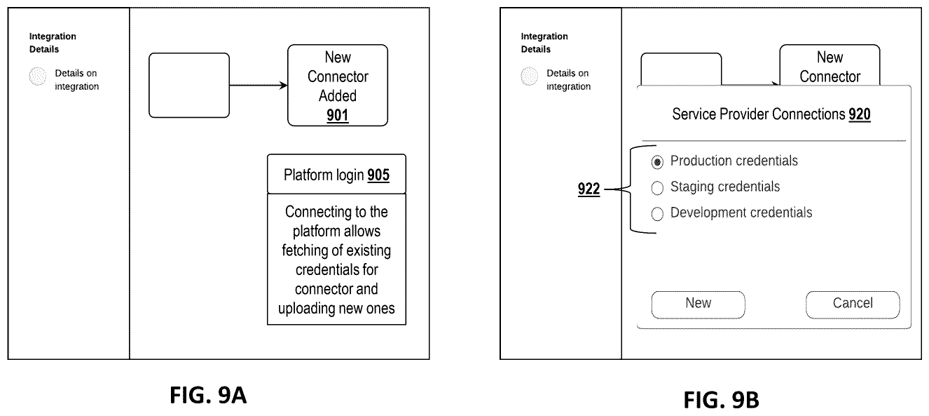

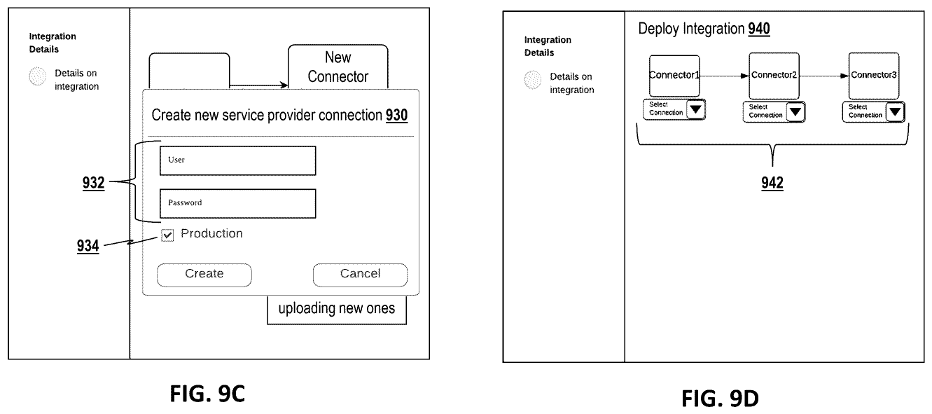

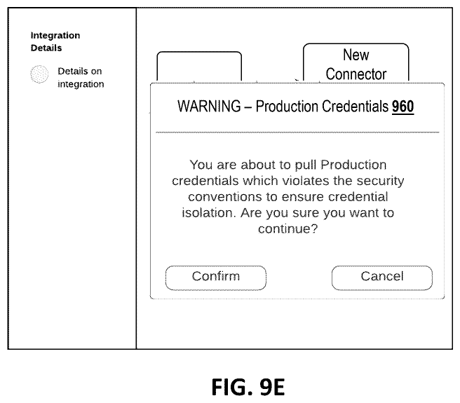

FIG. 9A illustrates an example graphical user interface (GUI) with a first graphical element 901 indicating addition of a new connector and a second graphical element 905 providing a recommendation for the user to log in to the platform to gain access to any existing credentials for the connector. The “platform” in this context refers to the external domain 139 with which manages authentication credentials for different service domains (such as the connection management services 142 of the external domain 130).

As mentioned, some implementations provide different types of authentication credentials depending on the context in which they will be used, where each type of authentication credential is associated with a different set of permissions. For example, FIG. 9B illustrates a pop-up window 920 presenting selectable credential types including (i) production, (ii) staging, and (iii) development. Here, development refers to constructing the integration via one or more integration code builder applications (such as integration code builder application 101), prior to staging and deployment (e.g., writing integration code, downloading and referencing code libraries, performing program code simulations and debugging, etc.). Staging refers to compiling and running the integration in a private (non-production) test environment, potentially on staging servers at a data center or within the integration domain. Production refers to the finalized version of the integration which is deployed and executed on a production platform (e.g., the data center deployment environment(s) 140 described above) to connect two or more operable service domains. In the example GUI in FIG. 9B, a set of radio buttons 922 are provided to select one of the three credential types.

Once a credential type is selected, the corresponding set of permissions are applied. For example, the permissions for development credentials may provide read access to only those service domain resources required for building the integration (e.g., permission to read portions of the service domain source code); the permissions for staging may provide access to a wider set of resources, potentially including read, write, and execute permissions associated with the test environment (e.g., based on the requirements of the staging environment); and the permissions for production credentials may provide read, write, execute, and delete access to any resources required to run the production version of the integration (e.g., read, write, execute, and delete permissions within a particular platform environment such as a virtual machine or container).

In some implementations, the authentication credential type dictates the locations where the authentication credentials may be stored. For example, in some implementations, copies of production credentials may only be stored as secure properties 161 until the deploy service 125 injects them into the corresponding connector during deployment, at which time they are deleted from the secure properties storage service 160. In one implementation, production credentials are only persistently stored in the external domain 130, until required by the deploy service 125 during deployment.

In contrast, non-production credentials such as development credentials with a limited set of permissions may be stored locally for development/testing purposes within the integration domain 120 and potentially the development domain 110. In these implementations, for example, each integration code builder application 101 includes credential management logic 104 which ensures that only certain types of authentication credentials are stored locally (e.g., development or staging credentials, or other credential types with limited permission sets). Depending on the user of the integration code builder application 101, the credential management logic 104 may encrypt and store the development credentials 106 on a local storage device (e.g., on a client or server machine). Moreover, storage of the encrypted development credentials 106 may be limited to the period of time that a corresponding user is logged in to the integration code builder application 101. When the user logs out from the integration code builder application 101, the credential management logic 104 may delete the development credentials 106.

FIG. 9C illustrates a pop up window 930 generated when the user chooses to create a new service provider connection using new authentication credentials. In the illustrated example, fields 932 are provided in the pop up window for entering a user name and password (i.e., as required by the corresponding service domain). In addition, a selectable checkbox 934 is provided which, when selected, indicates that the authentication credentials are intended for a production integration environment (e.g., as opposed to a development, staging, or other non-production environment). The authentication credentials may be credentials previously established through a direct connection to the corresponding service domain, but which have not yet been synchronized with the connection management services 142.

In response to the user entering the credentials, the external domain 130 and/or the integration domain 120 may use the credentials to attempt to connect to the corresponding service domain (e.g., service domain 190A). If the connection is successful, the management service 128 may send a request to the connection management services 142 via the bridge 126 to store and management the new authentication credentials. As previously described with respect to FIG. 3, the bridge 126 may enter into a sequence of transactions with the connection management services 142 to create the required resources for managing the new authentication credentials (at 304). The authentication credentials may then be managed within the external domain 130 in accordance with the credential type (e.g., with production credentials only being provided for integration deployments and non-production credentials being provided during non-production stages).

As mentioned, the credential management logic 104 of the integration code builder application 101 enforces defined mechanisms for protecting the authentication credentials (e.g., encrypting non-production credentials at rest based on, for example, a biometric user login and using the client machine's keychain). In cases where the production checkbox 934 is selected, local copies of the authentication credentials are prevented from being stored within the development domain 110. Rather, only the deploy service 125 and/or the management service 128 may access the production credentials, and only when writing them to the secure properties 161 and reading them from the secure properties 161 during deployment.

In some implementations, when the development, testing, and staging stages of the integration have been completed, the integration code builder application 101 may present an option to swap out the non-production credentials for the production credentials appropriate for the deployment, thereby updating the corresponding permission sets and triggering the deployment process.

FIG. 9D illustrates a graphical representation of each of the connectors 942 coupled within an integration deployment. The graphical element corresponding to each connector 942 includes a selectable drop-down menu allowing the user to select a particular connector to be used in the corresponding position. For example, different versions of the connectors, potentially with different schemas may be selected from the selectable drop-down menu.

Once the integration 145 has been successfully deployed or when development and testing have been completed, the integration code builder application 101 may generate and store one or more corresponding metadata files within the connector code repository 129 defining the parameters and configuration associated with the integration. The one or more metadata files can be used by future users to skip the introspection operations performed by the introspection service 122 and directly determine from the one or more metadata files, the placeholder locations in the connector code where the authentication credentials can be injected in an integration. The following is an example code sequence from an integration (also referred to as a flow) in which location indicates a placeholder, groupID indicates a logical grouping of the connection with other code sequences (e.g., the integration runtime 141), artifactID indicates the service domain associated with the connector, and version indicates the connector version:

```
{
      “flow”: [
        // A description of the flow, as with an
        XML format, but focused only on a
        connector and how the elements are represented
],
      “connections”: [
            {
                  “location”: “/flow0/trigger0”,
                  “groupId”: “com.mulesoft”,
                  “artifactId”: “slack”
                  “version”: “1.0.0”
},
...
]
}
```

In a large multi-service environment, a balance must be achieved between the cross-cutting concerns of security and maximum availability. Authenticated users should be provided with access to authentication credentials but based on the context for the use, as defined by security mechanisms. Some embodiments operate in accordance with a set of credential management policies or rules for protecting authentication credentials. For example, in some implementations, certain authentication credentials such as production credentials are not permitted to be permanently stored in any location outside of a deployed integration or within the domain which manages authentication credentials (referred to as the external domain 130 in some embodiments described herein). In these embodiments, the credential management policies/rules are implemented via a combination of the credentials management logic 104 of the integration code builder applications 101, the management service 128 of the integration domain 120, and the connection management services 142 of the external domain 130. For example, the credential management logic 104 of the integration code builder application 101 may ensure that only encrypted non-production credentials 106 are stored locally within the development domain 110. Similarly, the management service 128 may ensure that production credentials are securely stored as secure properties 161 and only read once, during deployment, and are subsequently deleted. The API 131 of the external domain 130 may ensure that production credentials are only released to the integration domain 120 for this limited purpose and only in response to an authenticated connection via the bridge 126.

In some embodiment, access to production credentials is also vetted and managed by administrators based on the level of access required for the intended purpose. For example, depending on the scenario, the actions of Read, Write, Edit, or Delete may (or may not) be provided for a given usage scenario.

The user interface feature of a production checkbox 934 shown in FIG. 9C enables flagging of new credentials (either at design time or development time) as credentials that are meant for production, meaning that they may impact the end-user of a live integration when used and they should be protected with a high level of security. Authentication credentials may be owned by the entity that created them, but production credentials are nonetheless prevented from being downloaded locally into the encrypted local storage of authentication credentials. As such, production credentials by default cannot be used for local debugging or local testing. Other credential types, such as development credentials, may be used for this purpose.

The following use cases are provided to demonstrate how authentication credentials are managed in certain implementations. Referring to FIG. 9E, in a first use case, when the owner of production credentials attempts to store the production credentials locally a warning pop-up window 960 explains that this action violates the security policy. Since the user already owns the credentials, they may confirm the warning and still have access to the production credentials. However, in some implementations, even the owner of the credentials is prevented from storing a local copy. Some implementations suggest an alternative to local storage of the production credentials, such as creating a new set of development credentials which will be sufficient for the expected usage of the credentials.

In a second use case, a user who is not the owner of the production credentials attempts to store a local copy. In this case, the user may only have the right to read the production credentials at the time of deployment, which means that the user can associate them to a deployment, but is prevented from downloading and storing them locally during non-production operations such as development or staging.

In a third use case, a user who is not the owner wants to use non-production credentials locally. Whether this user will be permitted to do so will depend on the permission set to which the user is bound. An example permission set has the following structure:
Resource: action
   where the resource comprises the set of non-production credentials and the action comprises one or more of: read, write, edit, delete, and execute. In some instances, the user may be provided with a local copy of non-production credentials. In other instances, the user is prevented from storing a local copy of the non-production credentials (depending on the permission set).

In some implementation, by default, when a new credential resource (e.g., someCred) is created, the following permissions are created by default:
Owner:
   Read (with warning during development/design time)
   Update
   Delete
Someone in the same business organization (Org):
   Read (non-production credentials only)

In accordance with this use-case, a non-owner can use credentials that they do not individually own, but that are owned by another user in the same Org. In some implementations, these default permissions are highly configurable, so a user who is not the owner may be permitted to have greater access through permission modifications by an administrator or potentially a credential owner.

In some implementations, when reading non-production credentials at development/design time, an encryption file is created to hold all the credentials and allow local testing and debugging, represented by the encrypted development credentials 106 in FIG. 1. This file is managed by the credential management logic 104 of the integration code builder application 101. The credential management logic 104 may require the user to perform a more secure authentication such as using biometric authentication and/or two-factor authentication (2FA) to access the encrypted non-production credentials 106 (e.g., only fingerprint authentication can be used to decrypt and read it). This ensures that even if stored locally in a vulnerable storage location, the credentials in the file are protected through an extra layer of encryption.

### Example Electronic Devices and Environments

### Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

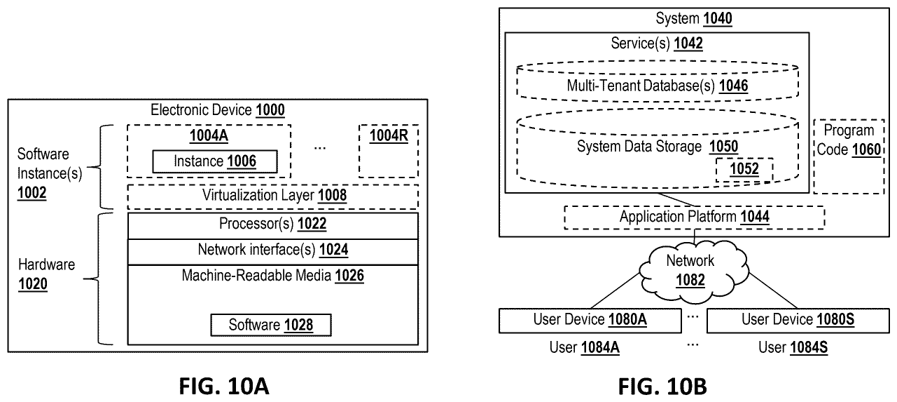

FIG. 10A is a block diagram illustrating an electronic device 1000 according to some example implementations. FIG. 10A includes hardware 1020 comprising a set of one or more processor(s) 1022, a set of one or more network interfaces 1024 (wireless and/or wired), and machine-readable media 1026 having stored therein software 1028 (which includes instructions executable by the set of one or more processor(s) 1022). The machine-readable media 1026 may include non-transitory and/or transitory machine-readable media. The various domains 110, 120, 130, 140 described herein may be implemented in one or more electronic devices 1000. In the development domain 110, for example, the integration code builder application 101 may run on a workstation and in the integration domain 120, the management service 128 and deploy service 125 may run on server hardware (comprising a memory and a plurality of execution cores). Some of the components described above, such as the bridge 126 and management service 128 enter into transactions with other components through a request-response protocol. In this arrangement, a component sending a request is a “client” with respect to that transaction and the component providing the response is the “server”. Various components described herein may perform the role of client and server (depending on whether they are sending a request or receiving a request and providing a response). In one implementation: 1) each of the components is implemented in a separate one of the electronic devices 1000 (e.g., in end user devices where the software 1028 represents the software to implement the integration code builder application 101 (e.g., software 1028 represents a web browser, a native client, a portal, a command-line interface, and/or an application programming interface (API) based upon protocols such as Simple Object Access Protocol (SOAP), Representational State Transfer (REST), etc.)); 2) each component is implemented in a separate set of one or more of the electronic devices 1000 (e.g., a set of one or more server devices where the software 1028 represents the functional modules described herein software to implement the corresponding functions); and 3) in operation, the electronic devices implementing the components would be communicatively coupled (e.g., by a network) and would establish between them (or through one or more other layers and/or or other services) connections for communicating requests and receiving responses as described herein. Other configurations of electronic devices may be used in other implementations.

During operation, an instance of the software 1028 (illustrated as instance 1006 and referred to as a software instance; and in the more specific case of an application, as an application instance) is executed. In electronic devices that use compute virtualization, the set of one or more processor(s) 1022 typically execute software to instantiate a virtualization layer 1008 and one or more software container(s) 1004A-1004R (e.g., with operating system-level virtualization, the virtualization layer 1008 may represent a container engine (such as Docker Engine by Docker, Inc. or rkt in Container Linux by Red Hat, Inc.) running on top of (or integrated into) an operating system, and it allows for the creation of multiple software containers 1004A-1004R (representing separate user space instances and also called virtualization engines, virtual private servers, or jails) that may each be used to execute a set of one or more applications; with full virtualization, the virtualization layer 1008 represents a hypervisor (sometimes referred to as a virtual machine monitor (VMM)) or a hypervisor executing on top of a host operating system, and the software containers 1004A-1004R each represent a tightly isolated form of a software container called a virtual machine that is run by the hypervisor and may include a guest operating system; with para-virtualization, an operating system and/or application running with a virtual machine may be aware of the presence of virtualization for optimization purposes). By way of example, and not limitation, each integration 145-146 described above may be run in a separate container and the integration runtime 141 may run as supervisory software to manage the integrations 145-146 (e.g., such as a hypervisor). Again, in electronic devices where compute virtualization is used, during operation, an instance of the software 1028 is executed within the software container 1004A on the virtualization layer 1008. In electronic devices where compute virtualization is not used, the instance 1006 on top of a host operating system is executed on the “bare metal” electronic device 1000. The instantiation of the instance 1006, as well as the virtualization layer 1008 and software containers 1004A-1004R if implemented, are collectively referred to as software instance(s) 1002.

Alternative implementations of an electronic device may have numerous variations from that described above. For example, customized hardware and/or accelerators might also be used in an electronic device.

### Example Environment

FIG. 10B is a block diagram of a deployment environment according to some example implementations. A system 1040 includes hardware (e.g., a set of one or more server devices) and software to provide service(s) 1042, including the management service 128, deploy service 125, and connection management services 142. In some implementations the system 1040 is in one or more datacenter(s). These datacenter(s) may be: 1) first party datacenter(s), which are datacenter(s) owned and/or operated by the same entity that provides and/or operates some or all of the software that provides the service(s) 1042; and/or 2) third-party datacenter(s), which are datacenter(s) owned and/or operated by one or more different entities than the entity that provides the service(s) 1042 (e.g., the different entities may host some or all of the software provided and/or operated by the entity that provides the service(s) 1042). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 1040 is coupled to user devices 1080A-1080S over a network 1082. For example, each integration code builder application 101 may be executed on a user device. The service(s) 1042 may be on-demand services that are made available to one or more of the users 1084A-1084S working for one or more entities other than the entity which owns and/or operates the on-demand services (those users sometimes referred to as outside users) so that those entities need not be concerned with building and/or maintaining a system, but instead may make use of the service(s) 1042 when needed (e.g., when needed by the users 1084A-1084S). The service(s) 1042 may communicate with each other and/or with one or more of the user devices 1080A-1080S via one or more APIs (e.g., a REST API). In some implementations, the user devices 1080A-1080S are operated by users 1084A-1084S, and each may be operated as a client device and/or a server device. In some implementations, one or more of the user devices 1080A-1080S are separate ones of the electronic device 1000 or include one or more features of the electronic device 1000.

In some implementations, the system 1040 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 1040 is a multi-tenant cloud computing architecture supporting multiple services, such as one or more of the following types of services: Pricing; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Cache-as-a-Service (CaaS); Analytics; Community; Internet-of-Things (IoT); Industry-specific; Artificial intelligence (AI); Application marketplace (“app store”); Data modeling; Security; and Identity and access management (IAM).

For example, system 1040 may include an application platform 1044 that enables PAAS for creating, managing, and executing one or more applications developed by the provider of the application platform 1044, users accessing the system 1040 via one or more of user devices 1080A-1080S, or third-party application developers accessing the system 1040 via one or more of user devices 1080A-1080S.

In some implementations, one or more of the service(s) 1042 may use one or more multi-tenant databases 1046, as well as system data storage 1050 for system data 1052 accessible to system 1040. In certain implementations, the system 1040 includes a set of one or more servers that are running on server electronic devices and that are configured to handle requests for any authorized user associated with any tenant (there is no server affinity for a user and/or tenant to a specific server). The user devices 1080A-1080S communicate with the server(s) of system 1040 to request and update tenant-level data and system-level data hosted by system 1040, and in response the system 1040 (e.g., one or more servers in system 1040) automatically may generate one or more Structured Query Language (SQL) statements (e.g., one or more SQL queries) that are designed to access the desired information from the multi-tenant database(s) 1046 and/or system data storage 1050.

In some implementations, the service(s) 1042 are implemented using virtual applications dynamically created at run time responsive to queries from the user devices 1080A-1080S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1060 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1044 includes an application setup mechanism that supports application developers' creation and management of applications, which may be saved as metadata by save routines. Invocations to such applications may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1082 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1040 and the user devices 1080A-1080S.

Each user device 1080A-1080S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1040. For example, the user interface device can be used to access data and applications hosted by system 1040, and to perform searches on stored data, and otherwise allow one or more of users 1084A-1084S to interact with various GUI pages that may be presented to the one or more of users 1084A-1084S. User devices 1080A-1080S might communicate with system 1040 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 1080A-1080S might include an HTTP client, commonly referred to as a “browser,” for sending and receiving HTTP messages to and from server(s) of system 1040, thus allowing users 1084A-1084S of the user devices 1080A-1080S to access, process and view information, pages and applications available to it from system 1040 over network 1082.

### Conclusion

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims.

What is claimed is:

1. A method implemented in a set of one or more electronic devices of an integration domain to perform an integration between a first service domain and a second service domain, the method comprising:
causing to be provided, within an integration development application running locally on a user device, a first set of one or more options and a second set of one or more options for respectively connecting the integration to the first service domain and the second service domain, wherein different options of the first set and the second set are associated with different corresponding authentication credentials managed by a connection management service of a third domain;
receiving an indication of a first selection and a second selection from the first set of options and the second set of options, respectively, the first selection corresponding to a first connector for connecting the integration to the first service domain and the second selection corresponding to a second connector for connecting the integration to the second service domain; and
deploying the integration in a data center with an instance of an integration runtime deployed in the data center, wherein the first connector comprises first connector code with at least a first placeholder for information to be used to authenticate the integration with the first service domain, and the second connector comprises second connector code with at least a second placeholder for information to be used to authenticate the integration with the second service domain, wherein deploying the integration comprises:
providing the first connector and the second connector to the integration runtime;
providing a mapping between the first placeholder and a location for accessing a first authentication credential associated with the first selection and between the second placeholder and a location for accessing a second authentication credential associated with the second selection; and
causing the integration to be executed by the integration runtime, which, based on the mapping and the first and second connector code, locates the first and second authentication credentials, respectively, and establishes first and second authenticated connections, respectively, with the first and second service domains by injecting the first authentication credential in accordance with the first placeholder and injecting the second authentication credential in accordance with the second placeholder.

2. The method of claim 1, further comprising:
determining, before the causing, the first set of options and the second set of options for connecting the integration to the first service domain and the second service domain, respectively, by:
detecting the first connector and the second connector through introspection of a codebase of existing integrations; and
determining, from the connection management service of the third domain, a first set of one or more existing authentication credentials for authenticating the integration with the first service domain and a second set of one or more existing authentication credentials for authenticating the integration with the second service domain, wherein the first set of options and the second set of options are based on the first set of one or more existing authentication credentials and the second set of one or more existing authentication credentials, respectively.

3. The method of claim 2, wherein detecting further comprises:
detecting an embedded authentication credential in at least one of the first connector and the second connector; and
replacing the embedded authentication credential with the first placeholder or the second placeholder, respectively.

4. The method of claim 1, wherein providing the mapping between the first and second placeholders comprises:
storing the first and second authentication credentials as secure properties in a secure properties storage accessible to the instance of the integration runtime, wherein the location for accessing the first authentication credential comprises a first location in the secure properties storage and the location for accessing the second authentication credential comprises a second location in the secure properties storage;
associating the first placeholder directly or indirectly with the first location; and
associating the second placeholder directly or indirectly with the second location.

5. The method of claim 4, wherein deploying the integration further comprises:
extracting the first and second authentication credentials from the first and second locations using the mapping;
causing the instance of the integration runtime to inject the first authentication credential in the first connector code in accordance with the first placeholder; and
causing the instance of the integration runtime to inject the second authentication credential in the second connector code in accordance with the second placeholder.

6. The method of claim 1, wherein the causing to be provided further comprises one or both of:
responsive to the user writing the first connector code in the integration development application, causing to be provided, within the integration development application running locally on the user device, at least a first indication to insert the first placeholder in the first connector code; and
responsive to the user writing the second connector code in the integration development application, causing to be provided, within the integration development application running locally on the user device, at least a second indication to insert the second placeholder in the first connector code.

7. The method of claim 6, wherein the first authentication credential is of a first type associated with a first set of permissions and the second authentication credential is of a second type associated with a second set of permissions, the first and second sets of permissions to be used to determine usage and storage requirements for the first and second authentication credentials, respectively.

8. The method of claim 7, wherein the first type is either a production credential type or a non-production credential type and the second type is either a production credential type or a non-production credential type.

9. The method of claim 8, wherein if the first type or the second type is the production credential type, then the first set of permissions or the second set of permissions are to indicate that the corresponding first authentication credential or second authentication credential are not to be stored locally on the user device.

10. The method of claim 9, wherein responsive to a user attempt to store the first authentication credential or the second authentication locally on the user device, blocking the attempt, transmitting a message indicating that the attempt violates security requirements, or both.

11. The method of claim 10, wherein the attempt is to be blocked if the user is not an owner of the first or second authentication credential and is to transmit the message if the user is the owner of the first or second authentication credential.

12. The method of claim 8, wherein if the first type or the second type is a non-production credential type, then the first set of permissions or the second set of permissions are to indicate that the corresponding first authentication credential or second authentication credential may be stored locally on the user device in accordance with the first or second sets of permissions, respectively, wherein the integration development application is to automatically encrypt and store the first authentication credential or second authentication credential in a secure storage only accessible to the integration development application.

13. The method of claim 12, wherein the non-production credential type comprises a development credential type associated with a development stage of the integration or a staging credential type associated with pre-production staging and testing of the integration.

14. The method of claim 7, further comprising:
inserting the first placeholder in the first connector code responsive to selection of the first option in the integration development application; and
inserting the second placeholder in the second connector code responsive to selection of the first option in the integration development application.

15. A machine-readable storage medium having program code stored thereon which, when executed by one or more processors associated with an integration domain, cause the one or more processors to perform operations to perform an integration between a first service domain and a second service domain, the operations comprising:
causing to be provided, within an integration development application running locally on a user device, a first set of one or more options and a second set of one or more options for respectively connecting the integration to the first service domain and the second service domain, wherein different options of the first set and the second set are associated with different corresponding authentication credentials managed by a connection management service of a third domain;
receiving an indication of a first selection and a second selection from the first set of options and the second set of options, respectively, the first selection corresponding to a first connector for connecting the integration to the first service domain and the second selection corresponding to a second connector for connecting the integration to the second service domain; and
deploying the integration in a data center with an instance of an integration runtime deployed in the data center, wherein the first connector comprises first connector code with at least a first placeholder for information to be used to authenticate the integration with the first service domain, and the second connector comprises second connector code with at least a second placeholder for information to be used to authenticate the integration with the second service domain, wherein deploying the integration comprises:
providing the first connector and the second connector to the integration runtime;
providing a mapping between the first placeholder and a location for accessing a first authentication credential associated with the first selection and between the second placeholder and a location for accessing a second authentication credential associated with the second selection; and
causing the integration to be executed by the integration runtime, which, based on the mapping and the first and second connector code, locates the first and second authentication credentials, respectively, and establishes first and second authenticated connections, respectively, with the first and second service domains by injecting the first authentication credential in accordance with the first placeholder and injecting the second authentication credential in accordance with the second placeholder.

16. The machine-readable storage medium of claim 15, further comprising program code to cause the operations of:
determining, before the causing, the first set of options and the second set of options for connecting the integration to the first service domain and the second service domain, respectively, by:
detecting the first connector and the second connector through introspection of a codebase of existing integrations; and
determining, from the connection management service of the third domain, a first set of one or more existing authentication credentials for authenticating the integration with the first service domain and a second set of one or more existing authentication credentials for authenticating the integration with the second service domain, wherein the first set of options and the second set of options are based on the first set of one or more existing authentication credentials and the second set of one or more existing authentication credentials, respectively.

17. The machine-readable storage medium of claim 16, wherein detecting further comprises:
detecting an embedded authentication credential in at least one of the first connector and the second connector; and
replacing the embedded authentication credential with the first placeholder or the second placeholder, respectively.

18. The machine-readable storage medium of claim 15, wherein providing the mapping between the first and second placeholders comprises:
storing the first and second authentication credentials as secure properties in a secure properties storage accessible to the instance of the integration runtime, wherein the location for accessing the first authentication credential comprises a first location in the secure properties storage and the location for accessing the second authentication credential comprises a second location in the secure properties storage;
associating the first placeholder directly or indirectly with the first location; and
associating the second placeholder directly or indirectly with the second location.

19. The machine-readable storage medium of claim 18, wherein deploying the integration further comprises:
extracting the first and second authentication credentials from the first and second locations using the mapping;
causing the instance of the integration runtime to inject the first authentication credential in the first connector code in accordance with the first placeholder; and
causing the instance of the integration runtime to inject the second authentication credential in the second connector code in accordance with the second placeholder.

20. The machine-readable storage medium of claim 15, wherein the causing to be provided further comprises one or both of:
responsive to the user writing the first connector code in the integration development application, causing to be provided, within the integration development application running locally on the user device, at least a first indication to insert the first placeholder in the first connector code; and
responsive to the user writing the second connector code in the integration development application, causing to be provided, within the integration development application running locally on the user device, at least a second indication to insert the second placeholder in the first connector code.

21. The machine-readable storage medium of claim 20, wherein the first authentication credential is of a first type associated with a first set of permissions and the second authentication credential is of a second type associated with a second set of permissions, the first and second sets of permissions to be used to determine usage and storage requirements for the first and second authentication credentials, respectively.

22. The machine-readable storage medium of claim 21, wherein the first type is either a production credential type or a non-production credential type and the second type is either a production credential type or a non-production credential type.

23. The machine-readable storage medium of claim 22, wherein if the first type or the second type is the production credential type, then the corresponding first set of permissions or second set of permissions are to indicate that the corresponding first authentication credential or second authentication credential are not to be stored locally on the user device.

24. The machine-readable storage medium of claim 23, wherein responsive to a user attempt to store the first authentication credential or the second authentication locally on the user device, blocking the attempt, transmitting a message indicating that the attempt violates security requirements, or both.

25. The machine-readable storage medium of claim 24, wherein the attempt is to be blocked if the user is not an owner of the first or second authentication credential and is to transmit the message if the user is the owner of the first or second authentication credential.

26. The machine-readable storage medium of claim 24, wherein if the first type or the second type is a non-production credential type, then the corresponding first or second sets of permissions are to indicate that the corresponding first authentication credential or second authentication credential may be stored locally on the user device in accordance with the first or second sets of permissions, respectively, wherein the integration development application is to automatically encrypt and store the first authentication credential or second authentication credential in a secure storage only accessible to the integration development application.

27. The machine-readable storage medium of claim 26, wherein the non-production credential type comprises a development credential type associated with a development stage of the integration or a staging credential type associated with pre-production staging and testing of the integration.

28. The machine-readable storage medium of claim 21, further comprising:
inserting the first placeholder in the first connector code responsive to selection of the first option in the integration development application; and
inserting the second placeholder in the second connector code responsive to selection of the first option in the integration development application.
